(19) United States
(12) Patent Application Publication
(10) Pub. No.: US 2025/0074002 A1
(43) Pub. Date: Mar. 6, 2025

(54) METHOD AND SYSTEM FOR FABRICATING AN OBJECT HAVING INTERNAL PILLARS

(71) Applicant: Stratasys Ltd., Rehovot (IL)

(72) Inventors: Barak GLASSMAN, Ness Ziona (IL); Yoav BRESSLER, Tel-Aviv (IL); Lior KHAIMOV, Lod (IL)

(73) Assignee: Stratasys Ltd., Rehovot (IL)

(21) Appl. No.: 18/724,704

(22) PCT Filed: Dec. 27, 2022
(86) PCT No.: PCT/IL2022/051396

§ 371 Date: Jun. 27, 2024

Related U.S. Application Data
(60) Provisional application No. 63/294,151, filed on Dec. 28, 2021.

(51) Int. Cl. B29C 64/386; B29C 64/112; B33Y 10/00; B33Y 50/00

(52) U.S. Cl. CPC B29C 64/386; B29C 64/112; B33Y 10/00; B33Y 50/00

(57) ABSTRACT

A method of additive manufacturing comprises receiving digital data defining a shape of a three-dimensional object and based on the digital data, sequentially dispensing and solidifying a plurality of layers made of a modeling material and arranged in a configured pattern corresponding to the shape of the object. A portion of the layers forms one or more stacks, each encompassing a non-solid substance trapped between a plurality of building material pillars oriented perpendicularly to the layers.

### RELATED APPLICATION

This application claims the benefit of priority of U.S. Provisional Patent Application No. 63/294,151 filed on Dec. 28, 2021, the contents of which are incorporated herein by reference in their entirety.

### FIELD AND BACKGROUND OF THE INVENTION

The present invention, in some embodiments thereof, relates to additive manufacturing and, more particularly, but not exclusively, to a method and system for fabricating an object having internal pillars.

Additive manufacturing (AM) is generally a process in which a three-dimensional (3D) object is manufactured utilizing a computer model of the objects. Such a process is used in various fields, such as design related fields for purposes of visualization, demonstration and mechanical prototyping, as well as for rapid manufacturing (RM). The basic operation of any AM system consists of slicing a three-dimensional computer model into thin cross sections, translating the result into two-dimensional position data and feeding the data to control equipment which manufacture a three-dimensional structure in a layerwise manner.

One type of AM is three-dimensional inkjet printing processes. In this process, a building material is dispensed from a dispensing head having a set of nozzles to deposit layers on a supporting structure. Depending on the building material, the layers may then be cured or solidified using a suitable device.

Various three-dimensional inkjet printing techniques exist and are disclosed in, e.g., U.S. Pat. Nos. 6,259,962, 6,569,373, 6,658,314, 6,850,334, 7,183,335, 7,209,797, 7,225,045, 7,300,619, 7,479,510, 7,500,846, 7,962,237, and International Publication No. WO2020/194318, the contents of which are hereby incorporated by reference. For example, International Publication No. WO2020/194318 discloses a technique in which an internal region of an object to be formed is defined with a structured air pocket. The air pocket can comprise an overhang that can be self-supporting and that can have an angle of 5°-15°.

### SUMMARY OF THE INVENTION

According to some embodiments of the invention the present invention there is provided a method of additive manufacturing. The method comprises receiving digital data defining a shape of a three-dimensional object and based on the digital data, sequentially dispensing and solidifying a plurality of layers arranged in a configured pattern corresponding to the shape of the object and being made of a modeling material. A portion of the layers preferably forms one or more stacks, each encompassing a non-solid substance trapped between a plurality of building material pillars oriented perpendicularly to the layers.

According to an aspect of some embodiments of the present invention there is provided a system of three-dimensional printing. The system comprises: a plurality of nozzle arrays configured for dispensing building materials; a solidification system configured for solidifying the materials; and a data processor having a circuit configured to receive digital data arranged over a plurality of slices each describing a cross-section of a layer of a three-dimensional object, to select a portion of the slices, and to superimpose on each slice of the portion a two-dimensional array of shapes, optionally and preferably concave shapes. The system preferably also comprises a computerized controller having a circuit configured for operating the nozzle arrays and the solidification system to sequentially dispense and solidify a plurality of layers, respectively corresponding to the plurality of slices. According to some embodiments of the invention a portion of the layers, which corresponds to the portion of the slices, forms a stack encompassing a non-solid substance trapped between a plurality of building material pillars oriented perpendicularly to the layers.

According to an aspect of some embodiments of the present invention there is provided a computer software product. The computer software product comprises a computer-readable medium in which program instructions are stored, which instructions, when read by a data processor, cause the data processor to receive digital data arranged over a plurality of slices each describing a cross-section of a layer of three-dimensional object, to select a portion of the slices, and to superimpose on each slice of the portion a two-dimensional array of shapes, optionally and preferably concave shapes. The portion of the slices defines a stack of layers encompassing a non-solid substance trapped between a plurality of building material pillars oriented perpendicularly to the layers.

According to some embodiments of the invention for each layer of the stack(s), a cross-section of each pillar at the layer forms a closed concave shape. According to some embodiments of the invention cross-section of each pillar has a size (for example, largest diameter) that gradually increases with a vertical position of the layer along the stack(s).

According to some embodiments of the invention for each layer of the stack(s), a cross-section of each pillar at the layer is selected based on the height map.

According to some embodiments of the invention the pillars are isolated from each other at one portion of the stack(s), and are interconnected thereamongst at another portion of the stack(s).

According to some embodiments of the invention the concave shape has rounded corners.

According to some embodiments of the invention the concave shape is devoid of non-rounded corners.

According to some embodiments of the invention the concave shape has at least four lobes pointing outwardly with respect to a center of the concave shape.

According to some embodiments of the invention at least a portion of the pillars are interconnected thereamongst.

According to some embodiments of the invention at least a portion of the pillars are interconnected thereamongst.

According to some embodiments of the invention the at least the portion of the pillars are interconnected at the lobes.

According to some embodiments of the invention the stack(s) comprises a lower part and an upper part, and wherein the pillars are interconnected via interconnects that are at the upper part.

According to some embodiments of the invention the lower part of the stack(s) is devoid of interconnects among the pillars.

According to some embodiments of the invention for each layer of the stack(s), a collection of concave shapes is distributed over the layer to form a two-dimensional periodic array.

According to some embodiments of the invention three-dimensional locations of the non-solid substance are described collectively by a two-variable periodic function having a plurality of discrete maxima.

According to some embodiments of the invention the two-variable periodic function is analytic.

According to some embodiments of the invention the two-variable periodic function is characterized by an equalized histogram.

According to some embodiments of the invention the received digital data define a shape of the three-dimensional object including the pillars.

According to some embodiments of the invention the received digital data define a solid shape of the three-dimensional object. According to some embodiments of the invention the method processes the digital data to define the pillars, wherein the dispensing is based on the processed data.

According to some embodiments of the invention the digital data is arranged over a plurality of slices, each describing a cross-section of the solid shape and corresponding to one of the plurality of layers. According to some embodiments of the invention the method selects a portion of the slices and superimposes on each slice of the portion a two-dimensional periodic array of concave shapes, each describing a cross-section of one of the pillars at a layer corresponding to the respective slice.

According to some embodiments of the invention the method comprises eroding each slice of the portion prior to the superimposing.

According to some embodiments of the invention the method comprises accessing a computer readable medium storing a data structure describing at least an elementary cell of the two-dimensional periodic array, wherein the superimposing is based on the data structure.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are schematic illustrations of an additive manufacturing system according to some embodiments of the invention;

FIGS. 2A-2C are schematic illustrations of printing heads according to some embodiments of the present invention;

FIGS. 3A and 3B are schematic illustrations demonstrating coordinate transformations according to some embodiments of the present invention;

FIG. 4 is a flowchart diagram of a method suitable for additive manufacturing, of a three-dimensional object in layers, according to various exemplary embodiments of the present invention;

FIGS. 5A-D are graphical representations of exemplified slices which can be used for fabricating layers of the object according to some embodiments of the present invention;

FIG. 6 is a schematic illustration of an object having a stack of layers that encompasses a plurality of internal pillars and a non-solid substance that is trapped in between the pillars;

FIGS. 7A-E are graphical representations of portions of slices, for the simplified case in which the object has a square cross-section;

FIGS. 8A, 8B, and 8C show, respectively, a contour plot, a two-dimensional plot, and a three-dimensional plot of a two-variable sinusoidal function which can be used for defining pillars, according to some embodiments of the present invention;

FIGS. 9A and 9B show, respectively, a contour plot, and a two-dimensional plot, of a numerical array obtained from the two-variable sinusoidal function;

FIG. 10 shows a histogram of the numerical array;

FIG. 11 shows a result of histogram equalization applied to the histogram of FIG. 10;

FIGS. 12A and 12B show, respectively, a contour plot, and a two-dimensional plot, of a numerical array to after histogram equalization;

FIGS. 13A, 13B, and 13C show, respectively, a contour plot, a two-dimensional plot, and a three-dimensional plot of a two-variable triangular function which can be used for defining pillars, according to some embodiments of the present invention;

FIG. 14 shows a height map of an exemplified object, according to some embodiments of the present invention;

FIG. 15 shows an exemplified slice describing a layer of an object according to some embodiments of the present invention;

FIGS. 16A and 16B are images of a three-dimensional object fabricated according to some embodiments of the present invention;

FIG. 17 is a flowchart diagram of a method suitable for selecting a ratio between amounts of modeling material and non-solid substance, according to various exemplary embodiments of the present invention; and

FIGS. 18A-B show experimental results demonstrating the ability of the technique of the present embodiments to provide an object characterized by negative HU values.

### DESCRIPTION OF SPECIFIC EMBODIMENTS OF THE INVENTION

The present invention, in some embodiments thereof, relates to additive manufacturing and, more particularly, but not exclusively, to method and system for fabricating an object having internal pillars.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The method and system of the present embodiments manufacture three-dimensional objects based on computer object data in a layerwise manner by forming a plurality of layers in a configured pattern corresponding to the shape of the objects. The formation of the layers is optionally and preferably by printing, more preferably by inkjet printing. The computer object data can be in any known format, including, without limitation, a Standard Tessellation Language (STL) or a StereoLithography Contour (SLC) format, an OBJ File format (OBJ), a 3D Manufacturing Format (3MF), Virtual Reality Modeling Language (VRML), Additive Manufacturing File (AMF) format, Drawing Exchange Format (DXF), Polygon File Format (PLY), or any other format suitable for Computer-Aided Design (CAD).

The term “object” as used herein refers to a whole three-dimensional object or a part thereof.

Each layer can be formed by an AM apparatus which scans a two-dimensional surface and patterns it. While scanning, the apparatus visits a plurality of target locations on the two-dimensional layer or surface, and decides, for each target location or a group of target locations, whether or not the target location or group of target locations is to be occupied by building material formulation, and which type of building material formulation is to be delivered thereto. The decision is made according to a computer image of the surface.

In preferred embodiments of the present invention the AM comprises three-dimensional printing, more preferably three-dimensional inkjet printing. In these embodiments a building material is dispensed from a printing head having one or more arrays of nozzles to deposit building material in layers on a supporting structure. The AM apparatus thus dispenses building material in target locations which are to be occupied and leaves other target locations void. The apparatus typically includes a plurality of arrays of nozzles, each of which can be configured to dispense a different building material. This is typically achieved by providing the printing head with a plurality of fluid channels separated from each other, wherein each channel receives a different building material through a separate inlet and conveys it to a different array of nozzles.

Thus, different target locations can be occupied by different building material formulations. The types of building material formulations can be categorized into two major categories: modeling material formulation and support material formulation. The support material formulation serves as a supporting matrix or construction for supporting the object or object parts during the fabrication process and/or other purposes, e.g., providing hollow or porous objects. Support constructions may additionally include modeling material formulation elements, e.g. for further support strength.

The modeling material formulation is generally a composition which is formulated for use in additive manufacturing and which is able to form a three-dimensional object on its own, i.e., without having to be mixed or combined with any other substance.

The final three-dimensional object is made of the modeling material formulation or a combination of modeling material formulations or modeling and support material formulations or modification thereof (e.g., following curing). All these operations are well-known to those skilled in the art of solid freeform fabrication.

In some exemplary embodiments of the invention an object is manufactured by dispensing two or more different modeling material formulations, each material formulation from a different array of nozzles (belonging to the same or different printing heads) of the AM apparatus. In some embodiments, two or more such arrays of nozzles that dispense different modeling material formulations are both located in the same printing head of the AM apparatus. In some embodiments, arrays of nozzles that dispense different modeling material formulations are located in separate printing heads, for example, a first array of nozzles dispensing a first modeling material formulation is located in a first printing head, and a second array of nozzles dispensing a second modeling material formulation is located in a second printing head.

In some embodiments, an array of nozzles that dispense a modeling material formulation and an array of nozzles that dispense a support material formulation are both located in the same printing head. In some embodiments, an array of nozzles that dispense a modeling material formulation and an array of nozzles that dispense a support material formulation are located in separate printing heads.

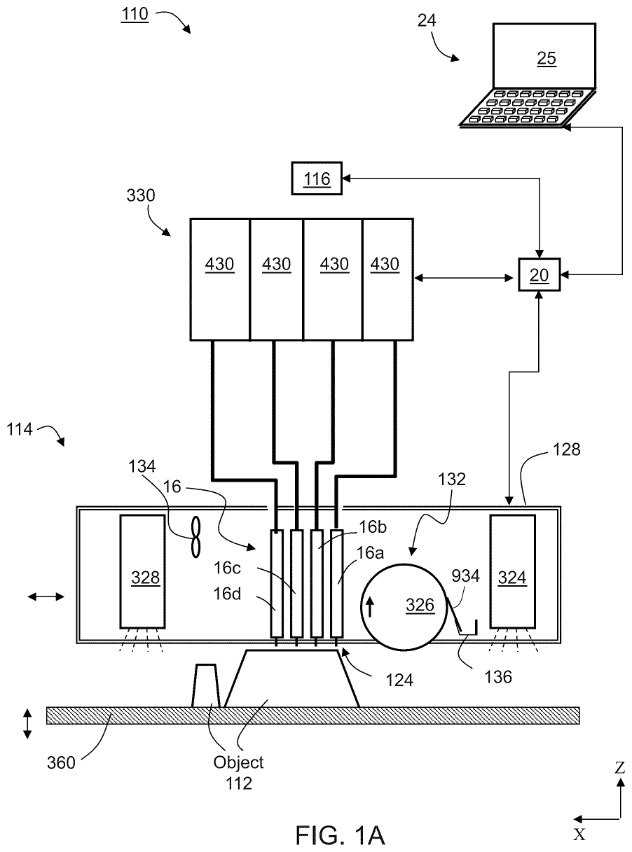

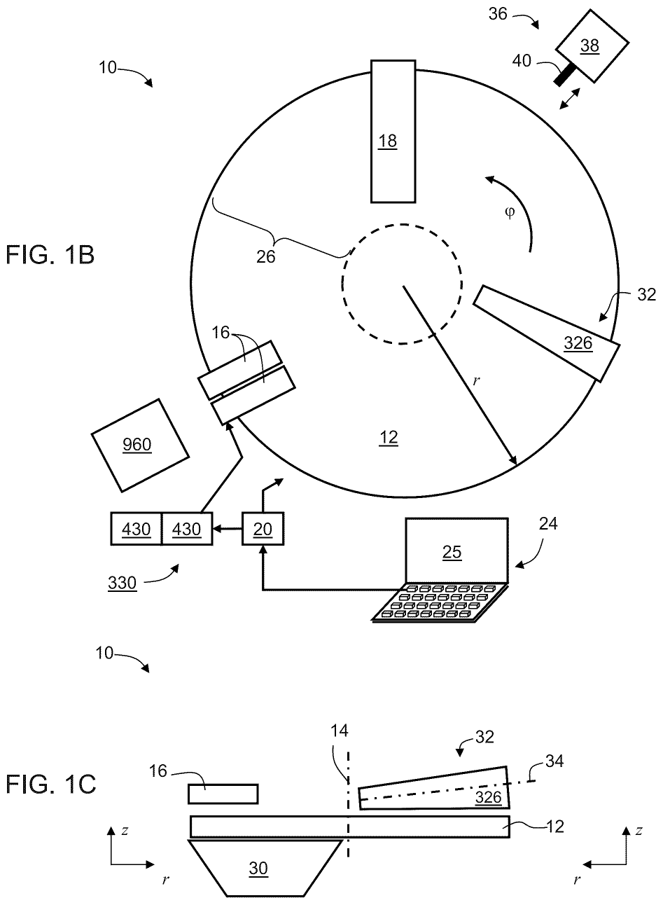

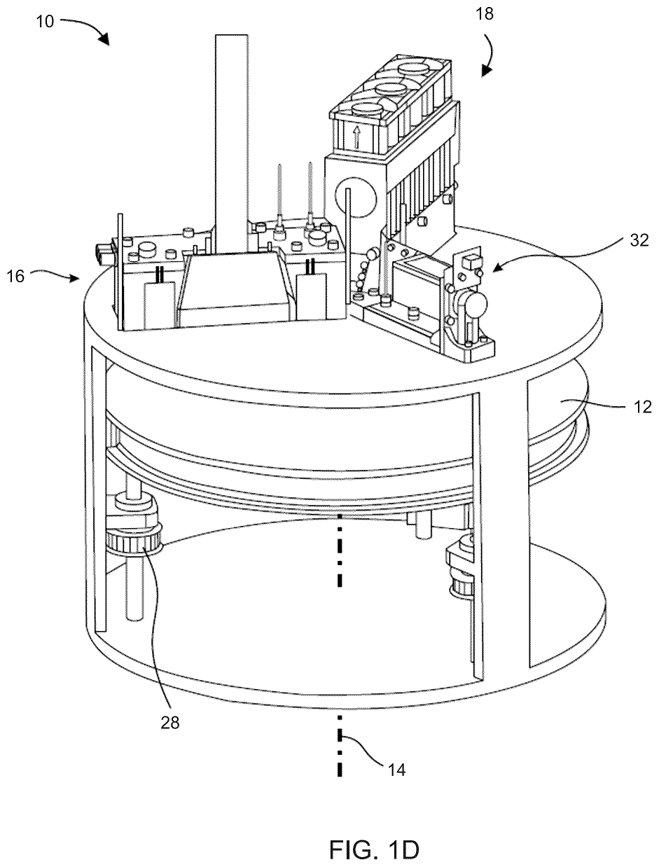

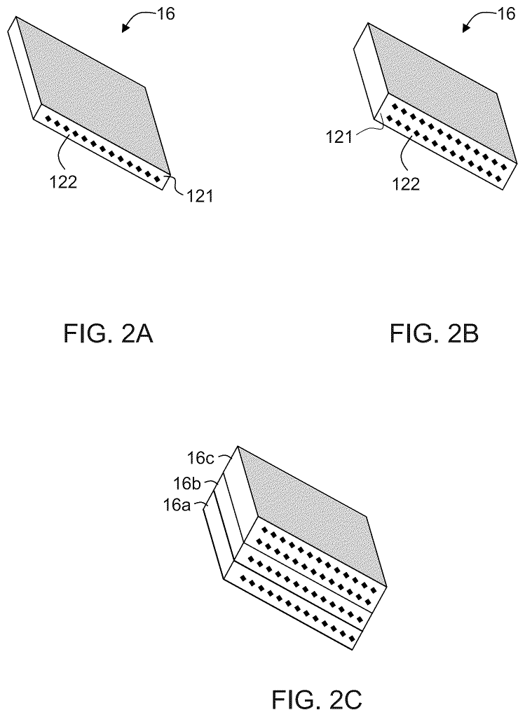

A representative and non-limiting example of a system 110 suitable for AM of an object 112 according to some embodiments of the present invention is illustrated in FIG. 1A. System 110 comprises an additive manufacturing apparatus 114 having a dispensing unit 16 which comprises a plurality of printing heads. Each head preferably comprises one or more arrays of nozzles 122, typically mounted on an orifice plate 121, as illustrated in FIGS. 2A-C described below, through which a liquid building material formulation 124 is dispensed.

Preferably, but not obligatorily, apparatus 114 is a three-dimensional printing apparatus, in which case the printing heads are printing heads, and the building material formulation is dispensed via inkjet technology. This need not necessarily be the case, since, for some applications, it may not be necessary for the additive manufacturing apparatus to employ three-dimensional printing techniques. Representative examples of additive manufacturing apparatus contemplated according to various exemplary embodiments of the present invention include, without limitation, fused deposition modeling apparatus and fused material formulation deposition apparatus.

Each printing head is optionally and preferably fed via one or more building material formulation reservoirs which may optionally include a temperature control unit (e.g., a temperature sensor and/or a heating device), and a material formulation level sensor. To dispense the building material formulation, a voltage signal is applied to the printing heads to selectively deposit droplets of material formulation via the printing head nozzles, for example, as in piezoelectric inkjet printing technology. Another example includes thermal inkjet printing heads. In these types of heads, there are heater elements in thermal contact with the building material formulation, for heating the building material formulation to form gas bubbles therein, upon activation of the heater elements by a voltage signal. The gas bubbles generate pressures in the building material formulation, causing droplets of building material formulation to be ejected through the nozzles. Piezoelectric and thermal printing heads are known to those skilled in the art of solid freeform fabrication. For any types of inkjet printing heads, the dispensing rate of the head depends on the number of nozzles, the type of nozzles and the applied voltage signal rate (frequency).

Optionally, the overall number of dispensing nozzles or nozzle arrays is selected such that half of the dispensing nozzles are designated to dispense support material formulation and half of the dispensing nozzles are designated to dispense modeling material formulation, i.e. the number of nozzles jetting modeling material formulations is the same as the number of nozzles jetting support material formulation. In the representative example of FIG. 1A, four printing heads 16a, 16b, 16c and 16d are illustrated. Each of heads 16a, 16b, 16c and 16d has a nozzle array. In this Example, heads 16a and 16b can be designated for modeling material formulation/s and heads 16c and 16d can be designated for support material formulation. Thus, head 16a can dispense one modeling material formulation, head 16b can dispense another modeling material formulation and heads 16c and 16d can both dispense support material formulation. In an alternative embodiment, heads 16c and 16d, for example, may be combined in a single head having two nozzle arrays for depositing support material formulation. In a further alternative embodiment any one or more of the printing heads may have more than one nozzle arrays for depositing more than one material formulation, e.g. two nozzle arrays for depositing two different modeling material formulations or a modeling material formulation and a support material formulation, each formulation via a different array or number of nozzles.

Yet it is to be understood that it is not intended to limit the scope of the present invention and that the number of modeling material formulation printing heads (modeling heads) and the number of support material formulation printing heads (support heads) may differ. In some embodiments, the number of arrays of nozzles that dispense modeling material formulation, the number of arrays of nozzles that dispense support material formulation, and the number of nozzles in each respective array are selected such as to provide a predetermined ratio, a, between the maximal dispensing rate of the support material formulation and the maximal dispensing rate of modeling material formulation. The value of the predetermined ratio, a, is preferably selected to ensure that in each formed layer, the height of modeling material formulation equals the height of support material formulation. Typical values for a are from about 0.6 to about 1.5.

As used herein throughout the term “about” refers to ±10%.

For example, for a=1, the overall dispensing rate of support material formulation is generally the same as the overall dispensing rate of the modeling material formulation when all the arrays of nozzles operate.

Apparatus 114 can comprise, for example, M modeling heads each having m arrays of p nozzles, and S support heads each having s arrays of q nozzles such that M×m×p=S×s×q. Each of the M×m modeling arrays and S×s support arrays can be manufactured as a separate physical unit, which can be assembled and disassembled from the group of arrays. In this embodiment, each such array optionally and preferably comprises a temperature control unit and a material formulation level sensor of its own, and receives an individually controlled voltage for its operation.

Apparatus 114 can further comprise a solidifying device 324 which can include any device configured to emit light, heat or the like that may cause the deposited material formulation to harden. For example, solidifying device 324 can comprise one or more radiation sources, which can be, for example, an ultraviolet or visible or infrared lamp, or other sources of electromagnetic radiation, or electron beam source, depending on the modeling material formulation being used. In some embodiments of the present invention, solidifying device 324 serves for curing or solidifying the modeling material formulation.

In addition to solidifying device 324, apparatus 114 optionally and preferably comprises an additional radiation source 328 for solvent evaporation. Radiation source 328 optionally and preferably generates infrared radiation. In various exemplary embodiments of the invention solidifying device 324 comprises a radiation source generating ultraviolet radiation, and radiation source 328 generates infrared radiation.

In some embodiments of the present invention apparatus 114 comprises cooling system 134 such as one or more fans or the like

The printing head(s) and radiation source are preferably mounted in a frame or block 128 which is preferably operative to reciprocally move over a tray 360, which serves as the working surface. In some embodiments of the present invention the radiation sources are mounted in the block such that they follow in the wake of the printing heads to at least partially cure or solidify the material formulations just dispensed by the printing heads. Tray 360 is positioned horizontally. According to the common conventions an X-Y-Z Cartesian coordinate system is selected such that the X-Y plane is parallel to tray 360. Tray 360 is preferably configured to move vertically (along the Z direction), typically downward. In various exemplary embodiments of the invention, apparatus 114 further comprises one or more leveling devices 32, e.g. a roller 326. Leveling device 326 serves to straighten, level and/or establish a thickness of the newly formed layer prior to the formation of the successive layer thereon. Leveling device 32 preferably comprises a waste collection device 136 for collecting the excess material formulation generated during leveling. Waste collection device 136 may comprise any mechanism that delivers the material formulation to a waste tank or waste cartridge.

In use, the printing heads of unit 16 move in a scanning direction, which is referred to herein as the X direction, and selectively dispense building material formulation in a predetermined configuration in the course of their passage over tray 360. The building material formulation typically comprises one or more types of support material formulation and one or more types of modeling material formulation. The passage of the printing heads of unit 16 is followed by the curing of the modeling material formulation(s) by radiation source 126. In the reverse passage of the heads, back to their starting point for the layer just deposited, an additional dispensing of building material formulation may be carried out, according to predetermined configuration. In the forward and/or reverse passages of the printing heads, the layer thus formed may be straightened by leveling device 32, which preferably follows the path of the printing heads in their forward and/or reverse movement. Once the printing heads return to their starting point along the X direction, they may move to another position along an indexing direction, referred to herein as the Y direction, and continue to build the same layer by reciprocal movement along the X direction. Alternately, the printing heads may move in the Y direction between forward and reverse movements or after more than one forward-reverse movement. The series of scans performed by the printing heads to complete a single layer is referred to herein as a single scan cycle.

Once the layer is completed, tray 360 is lowered in the Z direction to a predetermined Z level, according to the desired thickness of the layer subsequently to be printed. The procedure is repeated to form three-dimensional object 112 in a layerwise manner.

In another embodiment, tray 360 may be displaced in the Z direction between forward and reverse passages of the printing head of unit 16, within the layer. Such Z displacement is carried out in order to cause contact of the leveling device with the surface in one direction and prevent contact in the other direction.

The present embodiments contemplate use of a liquid material formulation supply system 330, which comprises one or more liquid material containers or cartridges 430, and which supplies the liquid material(s) to printing heads. Supply system 330 can be used in an AM system such as system 110, in which case the liquid material in each container is a building material.

A controller 20 controls fabrication apparatus 114 and optionally and preferably also supply system 330. Controller 20 typically includes an electronic circuit configured to perform the controlling operations. Controller 20 preferably communicates with a computer 24 which transmits digital data pertaining to fabrication instructions based on computer object data, e.g., a CAD configuration represented on a computer readable medium in a form of a Standard Tessellation Language (STL) format or the like. Typically, controller 20 controls the voltage applied to each printing head or each nozzle array and the temperature of the building material formulation in the respective printing head or respective nozzle array.

Once the manufacturing data is loaded to controller 20 it can operate without user intervention. In some embodiments, controller 20 receives additional input from the operator, e.g., using computer 24 or using a user interface 116 communicating with controller 20. User interface 116 can be of any type known in the art, such as, but not limited to, a keyboard, a touch screen and the like. For example, controller 20 can receive, as additional input, one or more building material formulation types and/or attributes, such as, but not limited to, color, characteristic distortion and/or transition temperature, viscosity, electrical property, magnetic property. Other attributes and groups of attributes are also contemplated.

Another representative and non-limiting example of a system 10 suitable for AM of an object according to some embodiments of the present invention is illustrated in FIGS. 1B-D. FIGS. 1B-D illustrate a top view (FIG. 1B), a side view (FIG. 1C) and an isometric view (FIG. 1D) of system 10.

In the present embodiments, system 10 comprises a tray 12 and a plurality of inkjet printing heads 16, each having one or more arrays of nozzles with respective one or more pluralities of separated nozzles. The material used for the three-dimensional printing is supplied to heads 16 by building material supply system 330, with one or more liquid material containers or cartridges 430, as further detailed hereinabove. Tray 12 can have a shape of a disk or it can be annular. Non-round shapes are also contemplated, provided they can be rotated about a vertical axis.

Tray 12 and heads 16 are optionally and preferably mounted such as to allow a relative rotary motion between tray 12 and heads 16. This can be achieved by (i) configuring tray 12 to rotate about a vertical axis 14 relative to heads 16, (ii) configuring heads 16 to rotate about vertical axis 14 relative to tray 12, or (iii) configuring both tray 12 and heads 16 to rotate about vertical axis 14 but at different rotation velocities (e.g., rotation at opposite direction). While some embodiments of system 10 are described below with a particular emphasis to configuration (i) wherein the tray is a rotary tray that is configured to rotate about vertical axis 14 relative to heads 16, it is to be understood that the present application contemplates also configurations (ii) and (iii) for system 10. Any one of the embodiments of system 10 described herein can be adjusted to be applicable to any of configurations (ii) and (iii), and one of ordinary skills in the art, provided with the details described herein, would know how to make such adjustment.

In the following description, a direction parallel to tray 12 and pointing outwardly from axis 14 is referred to as the radial direction r, a direction parallel to tray 12 and perpendicular to the radial direction r is referred to herein as the azimuthal direction o, and a direction perpendicular to tray 12 is referred to herein is the vertical direction z.

The radial direction r in system 10 enacts the indexing direction y in system 110, and the azimuthal direction o enacts the scanning direction x in system 110. Therefore, the radial direction is interchangeably referred to herein as the indexing direction, and the azimuthal direction is interchangeably referred to herein as the scanning direction.

The term “radial position,” as used herein, refers to a position on or above tray 12 at a specific distance from axis 14. When the term is used in connection to a printing head, the term refers to a position of the head which is at specific distance from axis 14. When the term is used in connection to a point on tray 12, the term corresponds to any point that belongs to a locus of points that is a circle whose radius is the specific distance from axis 14 and whose center is at axis 14.

The term “azimuthal position,” as used herein, refers to a position on or above tray 12 at a specific azimuthal angle relative to a predetermined reference point. Thus, radial position refers to any point that belongs to a locus of points that is a straight line forming the specific azimuthal angle relative to the reference point.

The term “vertical position,” as used herein, refers to a position over a plane that intersect the vertical axis 14 at a specific point.

Tray 12 serves as a building platform for three-dimensional printing. The working area on which one or objects are printed is typically, but not necessarily, smaller than the total area of tray 12. In some embodiments of the present invention the working area is annular. The working area is shown at 26. In some embodiments of the present invention tray 12 rotates continuously in the same direction throughout the formation of object, and in some embodiments of the present invention tray reverses the direction of rotation at least once (e.g., in an oscillatory manner) during the formation of the object. Tray 12 is optionally and preferably removable. Removing tray 12 can be for maintenance of system 10, or, if desired, for replacing the tray before printing a new object. In some embodiments of the present invention system 10 is provided with one or more different replacement trays (e.g., a kit of replacement trays), wherein two or more trays are designated for different types of objects (e.g., different weights) different operation modes (e.g., different rotation speeds), etc. The replacement of tray 12 can be manual or automatic, as desired. When automatic replacement is employed, system 10 comprises a tray replacement device 36 configured for removing tray 12 from its position below heads 16 and replacing it by a replacement tray (not shown). In the representative illustration of FIG. 1B tray replacement device 36 is illustrated as a drive 38 with a movable arm 40 configured to pull tray 12, but other types of tray replacement devices are also contemplated.

Exemplified embodiments for the printing head 16 are illustrated in FIGS. 2A-2C. These embodiments can be employed for any of the AM systems described above, including, without limitation, system 110 and system 10.

FIGS. 2A-B illustrate a printing head 16 with one (FIG. 2A) and two (FIG. 2B) nozzle arrays 22. The nozzles in the array are preferably aligned linearly, along a straight line. Printing head 16 is fed by a liquid material and dispenses it through the nozzle arrays 22, in response to a voltage signal applied thereto by the controller of the printing system. Head 16 is fed by a liquid material which is a building material formulation.

In embodiments in which a particular printing head has two or more linear nozzle arrays, the nozzle arrays are optionally and preferably can be parallel to each other. When a printing head has two or more arrays of nozzles (e.g., FIG. 2B) all arrays of the head can be fed with the same building material formulation, or at least two arrays of the same head can be fed with different building material formulations.

When a system similar to system 110 is employed, all printing heads 16 are optionally and preferably oriented along the indexing direction with their positions along the scanning direction being offset to one another.

When a system similar to system 10 is employed, all printing heads 16 are optionally and preferably oriented radially (parallel to the radial direction) with their azimuthal positions being offset to one another. Thus, in these embodiments, the nozzle arrays of different printing heads are not parallel to each other but are rather at an angle to each other, which angle being approximately equal to the azimuthal offset between the respective heads. For example, one head can be oriented radially and positioned at azimuthal position φ₁, and another head can be oriented radially and positioned at azimuthal position φ₂. In this example, the azimuthal offset between the two heads is φ₁-φ₂, and the angle between the linear nozzle arrays of the two heads is also φ₁-φ₂.

In some embodiments, two or more printing heads can be assembled to a block of printing heads, in which case the printing heads of the block are typically parallel to each other. A block including several inkjet printing heads 16a, 16b, 16c is illustrated in FIG. 2C.

In some embodiments, system 10 comprises a stabilizing structure 30 positioned below heads 16 such that tray 12 is between stabilizing structure 30 and heads 16. Stabilizing structure 30 may serve for preventing or reducing vibrations of tray 12 that may occur while inkjet printing heads 16 operate. In configurations in which printing heads 16 rotate about axis 14, stabilizing structure 30 preferably also rotates such that stabilizing structure 30 is always directly below heads 16 (with tray 12 between heads 16 and tray 12).

Tray 12 and/or printing heads 16 is optionally and preferably configured to move along the vertical direction z, parallel to vertical axis 14 so as to vary the vertical distance between tray 12 and printing heads 16. In configurations in which the vertical distance is varied by moving tray 12 along the vertical direction, stabilizing structure 30 preferably also moves vertically together with tray 12. In configurations in which the vertical distance is varied by heads 16 along the vertical direction, while maintaining the vertical position of tray 12 fixed, stabilizing structure 30 is also maintained at a fixed vertical position.

The vertical motion can be established by a vertical drive 28. Once a layer is completed, the vertical distance between tray 12 and heads 16 can be increased (e.g., tray 12 is lowered relative to heads 16) by a predetermined vertical step, according to the desired thickness of the layer subsequently to be printed. The procedure is repeated to form a three-dimensional object in a layerwise manner.

The operation of inkjet printing heads 16 and optionally and preferably also of one or more other components of system 10, e.g., the motion of tray 12, are controlled by a controller 20. The controller can have an electronic circuit and a non-volatile memory medium readable by the circuit, wherein the memory medium stores program instructions which, when read by the circuit, cause the circuit to perform control operations as further detailed below.

Controller 20 can also communicate with a host computer 24 which transmits digital data pertaining to fabrication instructions based on computer object data, e.g., in a form of a Standard

Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY), 3D Manufacturing Format (3MF), Object Files (OBJ) or any other format suitable for Computer-Aided Design (CAD). The object data formats are typically structured according to a Cartesian system of coordinates. In these cases, computer 24 preferably executes a procedure for transforming the coordinates of each slice in the computer object data from a Cartesian system of coordinates into a polar system of coordinates. Computer 24 optionally and preferably transmits the fabrication instructions in terms of the transformed system of coordinates. Alternatively, computer 24 can transmit the fabrication instructions in terms of the original system of coordinates as provided by the computer object data, in which case the transformation of coordinates is executed by the circuit of controller 20.

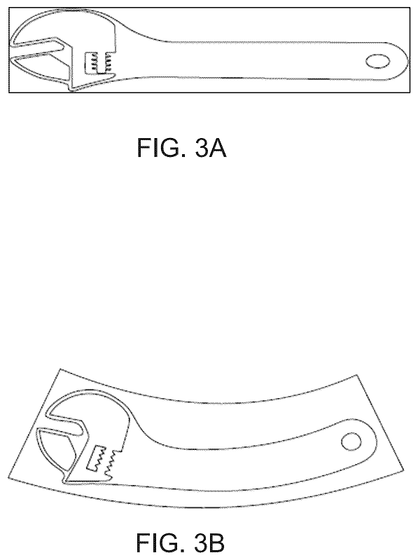

The transformation of coordinates allows three-dimensional printing over a rotating tray. In non-rotary systems with a stationary tray with the printing heads typically reciprocally move above the stationary tray along straight lines. In such systems, the printing resolution is the same at any point over the tray, provided the dispensing rates of the heads are uniform. In system 10, unlike non-rotary systems, not all the nozzles of the head points cover the same distance over tray 12 during at the same time. The transformation of coordinates is optionally and preferably executed so as to ensure equal amounts of excess material formulation at different radial positions. Representative examples of coordinate transformations according to some embodiments of the present invention are provided in FIGS. 3A-B, showing three slices of an object (each slice corresponds to fabrication instructions of a different layer of the objects), where FIG. 3A illustrates a slice in a Cartesian system of coordinates and FIG. 3B illustrates the same slice following an application of a transformation of coordinates procedure to the respective slice.

Typically, controller 20 controls the voltage applied to the respective component of the system 10 based on the fabrication instructions and based on the stored program instructions as described below.

Generally, controller 20 controls printing heads 16 to dispense, during the rotation of tray 12, droplets of building material formulation in layers, such as to print a three-dimensional object on tray 12.

System 10 optionally and preferably comprises one or more radiation sources 18, which can be, for example, an ultraviolet or visible or infrared lamp, or other sources of electromagnetic radiation, or electron beam source, depending on the modeling material formulation being used. Radiation source can include any type of radiation emitting device, including, without limitation, light emitting diode (LED), digital light processing (DLP) system, resistive lamp and the like. Radiation source 18 serves for curing or solidifying the modeling material formulation. In various exemplary embodiments of the invention the operation of radiation source 18 is controlled by controller 20 which may activate and deactivate radiation source 18 and may optionally also control the amount of radiation generated by radiation source 18.

In some embodiments of the invention, system 10 further comprises one or more leveling devices 32 which can be manufactured as a roller 326 or a blade. Leveling device 32 serves to straighten the newly formed layer prior to the formation of the successive layer thereon. In some embodiments, leveling device 32 has the shape of a conical roller positioned such that its symmetry axis 34 is tilted relative to the surface of tray 12 and its surface is parallel to the surface of the tray. This embodiment is illustrated in the side view of system 10 (FIG. IC).

The conical roller can have the shape of a cone or a conical frustum.

The opening angle of the conical roller is preferably selected such that there is a constant ratio between the radius of the cone at any location along its axis 34 and the distance between that location and axis 14. This embodiment allows roller 32 to efficiently level the layers, since while the roller rotates, any point p on the surface of the roller has a linear velocity which is proportional (e.g., the same) to the linear velocity of the tray at a point vertically beneath point p. In some embodiments, the roller has a shape of a conical frustum having a height h, a radius R₁ at its closest distance from axis 14, and a radius R₂ at its farthest distance from axis 14, wherein the parameters h, R₁ and R₂ satisfy the relation R₁/R₂=(R−h)/h and wherein R is the farthest distance of the roller from axis 14 (for example, R can be the radius of tray 12).

The operation of leveling device 32 is optionally and preferably controlled by controller 20 which may activate and deactivate leveling device 32 and may optionally also control its position along a vertical direction (parallel to axis 14) and/or a radial direction (parallel to tray 12 and pointing toward or away from axis 14.

In some embodiments of the present invention printing heads 16 are configured to reciprocally move relative to tray along the radial direction r. These embodiments are useful when the lengths of the nozzle arrays 22 of heads 16 are shorter than the width along the radial direction of the working area 26 on tray 12. The motion of heads 16 along the radial direction is optionally and preferably controlled by controller 20.

Some embodiments contemplate the fabrication of an object by dispensing different material formulations from different arrays of nozzles (belonging to the same or different printing head). These embodiments provide, inter alia, the ability to select material formulations from a given number of material formulations and define desired combinations of the selected material formulations and their properties. According to the present embodiments, the spatial locations of the deposition of each material formulation with the layer is defined, either to effect occupation of different three-dimensional spatial locations by different material formulations, or to effect occupation of substantially the same three-dimensional location or adjacent three-dimensional locations by two or more different material formulations so as to allow post deposition spatial combination of the material formulations within the layer, thereby to form a composite material formulation at the respective location or locations.

Any post deposition combination or mix of modeling material formulations is contemplated. For example, once a certain material formulation is dispensed it may preserve its original properties. However, when it is dispensed simultaneously with another modeling material formulation or other dispensed material formulations which are dispensed at the same or nearby locations, a composite material formulation having a different property or properties to the dispensed material formulations may be formed.

In some embodiments of the present invention the system dispenses digital material formulation for at least one of the layers.

The phrase “digital material formulations”, as used herein and in the art, describes a combination of two or more material formulations on a pixel level or voxel level such that pixels or voxels of different material formulations are interlaced with one another over a region. Such digital material formulations may exhibit new properties that are affected by the selection of types of material formulations and/or the ratio and relative spatial distribution of two or more material formulations.

As used herein, a “voxel” of a layer refers to a physical three-dimensional elementary volume within the layer that corresponds to a single pixel of a bitmap describing the layer. The size of a voxel is approximately the size of a region that is formed by a building material, once the building material is dispensed at a location corresponding to the respective pixel, leveled, and solidified.

The present embodiments thus enable the deposition of a broad range of material formulation combinations, and the fabrication of an object which may consist of multiple different combinations of material formulations, in different parts of the object, according to the properties desired to characterize each part of the object.

Further details on the principles and operations of an AM system suitable for the present embodiments are found in U.S. Pat. No. 9,031,680, the contents of which are hereby incorporated by reference.

The present embodiments comprise a technique for fabricating a three-dimensional object which comprises internal pillars by additive manufacturing. Three-dimensional regions between the internal pillars do not contain building material, but contain a non-solid substance, optionally and preferably a gas, such as, but not limited to, air. Thus, the non-solid substance is trapped between the internal pillars. The advantage of fabricating a three-dimensional object with regions that do not contain building material is that the amount of building material that is required, and typically also the amount of produced waste and/or the associated fabrication cost, is reduced. Since the regions between the pillars are made of a substance that is different from the building material (e.g., air), their mechanical properties (e.g., elasticity, compliance) are typically different from the mechanical properties of the building material, and so the amount, the size, and/or the distribution of the pillars within the object can be selected to provide the object with mechanical properties that would not be obtainable had the object been a conventional solid object.

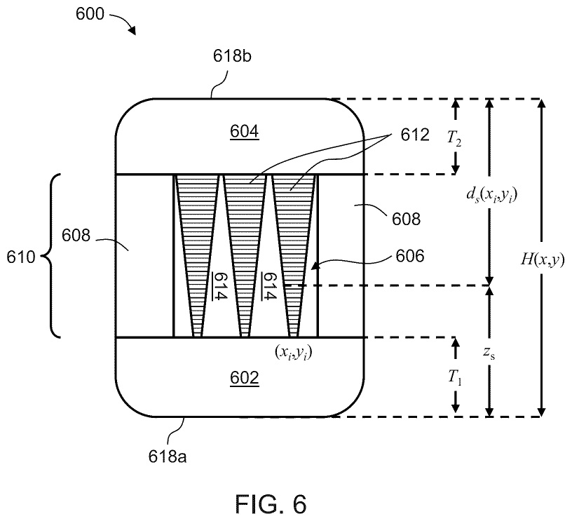

The pillars are internal with respect to the outer surface of the object in the sense that they occupy a three-dimensional region within the object that is closed from below and from above by one or more continuous layers of building material(s) and that is laterally surrounded by one or more continuous walls of building material(s). This is schematically illustrated in FIG. 6.

FIG. 6 illustrates an object 600, having a region 602 at a lower part thereof, and a region 604 at an upper part thereof. Each of regions 602 and 604 comprises a stack of layers. The thickness of region 602 along the vertical direction is denoted T₁, and the thickness of region 604 along the vertical direction is denoted T₂. In some embodiments of the present invention T₁ and T₂ are uniform across the respective region. In these embodiments, when the upper surface 618b and the lower surface 618a of the object 600 are planar and horizontal, all the points that form the bottommost surface of region 604 are on the same layer of the object 600, and all the points that form the topmost surface of region 602 are on the same layer of the object 600. However, this need not necessarily be the case, since at least one of the upper outer surface 618b and the lower outer surface 618a of the object 600 may be not planar and horizontal. Thus, the points that form the bottommost surface of region 604 may, in some embodiments, be on different layers, and the points that form the topmost surface of region 602 may in some embodiments, be on different layers.

Object 600 also comprises a stack 610 of layers (individual layers not shown) between regions 602 and 604. Stack 610 encompasses an internal region 606 and a peripheral wall 608 surrounding the internal region 606. Internal region 606 comprises a plurality of internal pillars 612, and a non-solid substance 614 that is trapped in region 606 between the pillars 612. In at least one layer of object 600, a continuous non-solid region is formed by non-solid substance 614.

Thus, neither the pillars 612 nor the regions between the pillars impose any compromise on the outer appearance of the object, since the pillars and the regions between the pillars are isolated from the surroundings of the object, a configuration which is particularly advantageous when the non-solid substance 614 is a fluid (e.g. gas, liquid, or a combination thereof). Compared to some plastics, objects formed by AM, for example, using photopolymer materials tend to be heavy, which may be a drawback for some applications. Allowing the inter-pillar regions to be gaseous is therefore advantageous since it reduces the overall weight of the fabricated object.

While FIG. 6 illustrates a configuration in which object 600 comprises a single region 602, a single stack 610, and a single stack 604, this need not necessarily be the case, since in some embodiments of the present invention, object 600 may include two or more stacks 610 one above the other, wherein one or more regions which do not include pillars (e.g., region 604 or region 602) are between two adjacent stacks 610. These embodiments add mechanical strength, particularly for tall objects.

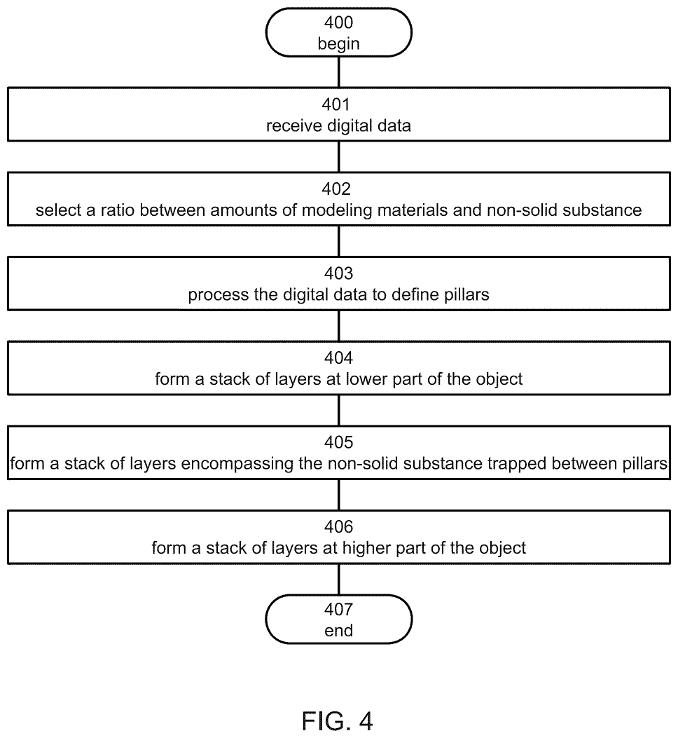

FIG. 4 is a flowchart diagram of a method suitable for additive manufacturing, of a three-dimensional object in layers, according to various exemplary embodiments of the present invention. Selected operations described below can be executed by the system described above (e.g., system 10 or 110). It is to be understood that, unless otherwise defined, the operations described hereinbelow can be executed either contemporaneously or sequentially in many combinations or orders of execution. Specifically, the ordering of the flowchart diagrams below is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method begins at 400 and proceeds to 401 at which digital data that collectively pertains to a three-dimensional shape of the object is received. For example, the computer (e.g., data processor 24) can access a computer-readable storage medium and retrieve the data from the medium. The data processor can also generate the data, or a portion thereof, instead of, or in addition to, retrieving data from the storage medium, for example, by means of computer aided design (CAD) software or computer aided manufacturing (CAM) software.

The digital data can be in the form of computer object data including a plurality of graphic elements (e.g., a mesh of polygons, non-uniform rational basis splines, etc.) defining a surface of the object. In some embodiments of the present invention the graphic elements are transformed by the method to a grid of voxels defining the shape of the object, for example, using a slicing procedure that generates slice data in the form of a plurality of slices, each comprising a plurality of voxels describing a cross-section of the 3D object and corresponding to a layer of the 3D object. Alternatively, the digital data received at 401 can be in the form of slice data, in which it is not necessary to execute the slicing operation. The digital data can optionally and preferably also include information pertaining to the type of building material(s) to be used for printing the object. The digital data can be in any data format known in the art, including, any of the aforementioned computer object data formats.

The data obtained at 401 can optionally and preferably also include data pertaining to the three-dimensional locations of the internal pillars 612 within the object to be manufactured. These data can be provided as graphic elements, similarly to the way the surface of the object is described by the aforementioned computer object data.

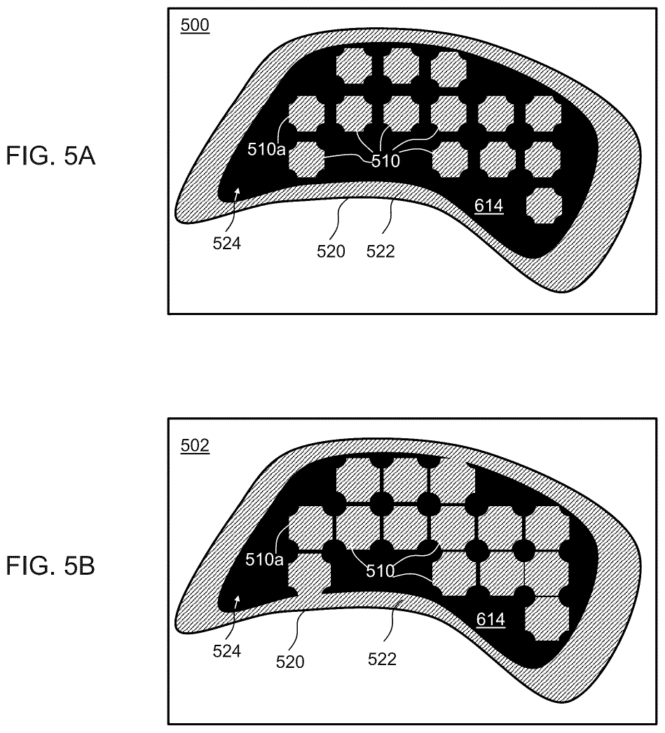

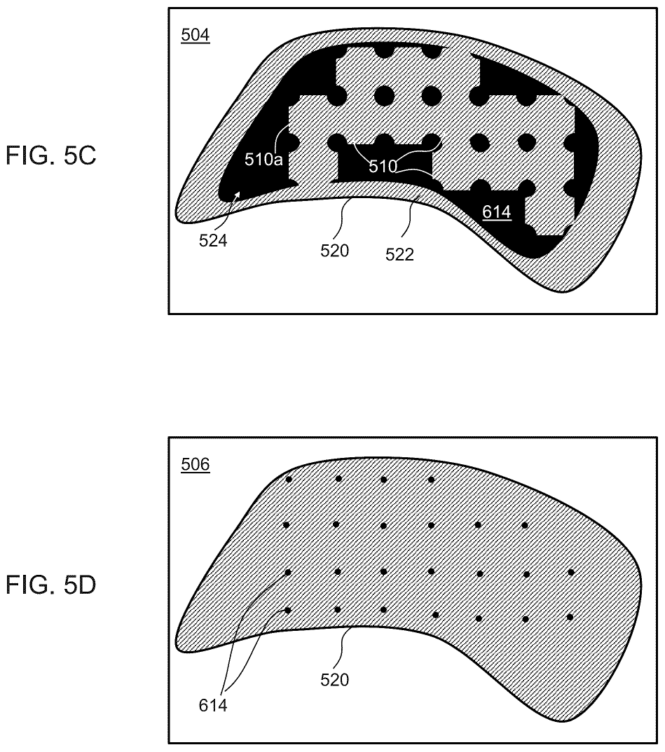

More preferably, these data are provided as part of the slice data. In this case, the data pertaining to the locations of the pillars 612 are included in a portion of the slices that defines a stack of layers in which the pillars 612 are to be formed. Each slice in this portion includes both information pertaining to the shape of the external surface or surfaces of the object, and information pertaining to the shapes and locations of the cross-sections of the pillars 612 at the respective layer. Graphical representations, which are not to be considered as limiting, of three exemplified slices 500, 502, and 504 of this portion are schematically illustrated in FIGS. 5A, 5B and 5C, respectively. Slice 500 describes a layer that is below the layer described by slice 502, and slice 502 describes a layer that is below the layer described by slice 504. The part of the stack that includes the layers described by slices 500 and 502, is referred to herein as the lower part of the stack, and part of the stack that includes the layer described by slice 504, is referred to herein as the upper part of the stack.

In FIGS. 5A-C, hatched regions represent regions to be occupied by building (modeling or support) materials(s), white region represents the space outside the cross-section of the 3D object to be manufactured (and therefore regions that are to be vacant from any building material), and black regions represent the inter-pillar regions which are to contain the non-solid substance. In the preferred embodiments in which the non-solid substance is air, both the black and the white regions are regions that are to be vacant from any material other than air.

Shown in FIGS. 5A-C are a boundary 520 of a layer of the object to be formed, and an envelope 522 surrounding an internal region 524 of the layer. Once the stack of layers is formed according to the slice data, the envelopes 522 combine to form peripheral wall 608 along the external surface of the object. Also shown, within internal region 524, are closed concave shapes 510 that are distributed laterally across each of slices 500, 502 and 504. Each of concave shapes 510 describes the cross-section of one of the pillars 612 at the respective layer of the object to be fabricated. The black areas are the non-solid substance 614 (e.g., air) that is trapped between the pillars 612 within the internal region surrounded by the aforementioned peripheral wall 608.

As used herein “concave shape” refers to any two-dimensional shape that includes at least one pair of points on its periphery, wherein the pair of points is characterized in that when the points of the pair are connected by a straight line, at least a segment of the straight line lies outside the shape. For example, a circle is not a concave shape, but a heart symbol is a concave shape.

It is to be understood that the various features in FIGS. 5A-C are not shown to scale. In particular, the number of pillars, and the sizes of the cross-sections of the pillars relative to the size of the boundary of the layer are not necessarily as illustrated. Typically, the diameter of at least one, or at least two, or at least three, or more of the pillars, at the lower part of the stack, is from about 5 drops of building material, to about 15 drops of building materials. Depending on the accuracy of dispensing, the diameter at the lower part of the stack may, according to some embodiments of the present invention, be even smaller than 5 drops of building material, e.g., 5 or less drops of building material. Pillars having a diameter larger than 15 drops of building materials at the lower part of the stack, are also contemplated, for example, when it is desired to impart certain mechanical properties to the stack.

The diameter of a single drop of building material is typically from about 10 μm to about 200 μm, or from about 80 μm to about 150 μm.

The concave shapes 510 can be polygons, or they can have one or more rounded corners. In some embodiments of the present invention there is at least one concave shape which is devoid of non-rounded corners, more preferably each of the concave shapes is devoid of non-rounded corners.

At each slice, the concave shapes 510 can be of same shape, or they can be of different shapes. Constructing the slices such that for each slice all the concave shapes 510 are of the same shape is advantageous from the standpoint of simplicity of the design. In the schematic illustrations shown in FIGS. 5A-C the concave shapes 510 have four lobes pointing outwardly with respect to the centers of the concave shapes. However, other shapes (for example, shapes with more than four lobes, e.g., star-like shapes) are also contemplated according to some embodiments of the present invention.

As illustrated in FIGS. 5A-C, for each pillar, there is a gradual increase in the size of its cross-sections with the vertical position of the layer along the stack. Consider, for example, the concave shapes shown at 510a. These shapes describe the cross-sections of a particular pillar at the layers corresponding to slices 500, 502 and 504. As illustrated, the size of shape 510a is larger in slice 502 than in slice 500, and is larger in slice 504 than in slice 502. Since the layer described by slice 500 is below the layer described by slice 502, and the layer described by slice 502 is below the layer described by slice 504, the cross-section of this particular pillar gradually increases upwards along the stack.

Preferably, the diameter of a cross section of the ith pillar at a particular layer s is selected based on the vertical distance dₛ(xᵢ,yᵢ) between the particular layer, at the lateral location (xᵢ,yᵢ) of that pillar, and the upper surface 618 of the object to be manufactured. The lateral location (xᵢ,yᵢ ) can be defined for example, as the lateral location of the voxel at the center of the cross section of the pillar. The vertical distance dₛ(xᵢ, yᵢ) can be calculated using the height map H(x,y) of the object, which provides the vertical height of the object at each lateral location (x,y). The height map H(x,y) can be received together with the digital data at 401, or, alternatively, it can be calculated based on the digital data received at 401.

In some embodiments of the present invention dₛ(xᵢ,yᵢ) is calculated according to the expression d(xᵢ,yᵢ)=H (xᵢ, yᵢ)−T₂- [symbol] , where H(xᵢ, yᵢ) is the value of the height map at the lateral location (xᵢ,yᵢ) of the ith pillar, [symbol] is the vertical distance of the layer s from the bottom 618a of the object, and T₂ is, as stated, the thickness of the region 604 (see FIG. 6). Preferably, the diameter of a cross section of each pillar is a decreasing function of dₛ, so that larger diameters are selected for smaller values of dₛ.

FIGS. 5A-C illustrate a simplified situation in which dₛ(x,y) is constant across the respective layers, thus showing a configuration in which, at each layer, all the concave shapes are of the same diameter. Such a situation occurs when the upper surface of the object to be manufactured is a horizontal plane. However, it is appreciated that such situations are rarely attainable (albeit contemplated in some embodiments), and so, generally, at a particular layer of the object, different diameters may be defined for the cross-sections of different pillars.

In some embodiments of the present invention the concave shapes are distributed over the slice to form a two-dimensional periodic array. For example, the three-dimensional locations to be occupied by the non-solid substance can be described collectively by a two-variable periodic function having a plurality of discrete maxima, and the locations of the concave shapes at each slice, can be complementary to the equivalued lines of the two-variable periodic function at the respective slice. Specifically, denoting the two-variable periodic function by f(x,y), and denoting the equivalued lines defined over the slice that describes the layer s by the equation f(x,y)=dₛ(x,y) can define the borders between regions in the slice that correspond to cross-section of the pillars, and regions in the slice that correspond to the trapped non-solid substance. A more detailed description of a procedure for defining the pillars' cross-section using two-variable periodic function is provided in the Examples section that follows.

The two-variable periodic function can be analytic or be provided in the form of a lookup table. In some embodiments of the present invention the two-variable periodic function is characterized by an equalized histogram, as further detailed in the Examples section that follows.

In some embodiments of the present invention at least a portion of pillars are interconnected thereamongst. Typically, when the cross-sections of the pillars include four outwardly pointing lobes, the lobes serve as interconnects among adjacent pillars. The interconnection between pillars do not necessarily extend throughput the height of the pillars, so as to increase the inter-pillar volume. Preferably, as illustrated in FIGS. 5A-D, at the lower part of the stack (FIGS. 5A and 5B), al least some of the pillars, and more preferably all the pillars, are separated from each other, such that in this part of the stack each separated pillar is surrounded from all sides by the non-solid substance 614. At the upper part of the stack (FIGS. 5C and 5D), the sizes of the pillars' cross-sections are sufficiently large so that the pillars interconnect at the interphases of the adjacent cross-sections. As one moves upwards in the stack, the cross-sections increase in size and so the interconnections between the pillars become thicker. The interconnections between pillars form separating walls between adjacent regions that are designated for the non-solid substance 614, so that, eventually, as one moves to slices that are sufficiently close to the top of the stack, all the regions of the slice that are designated for the non-solid substance 614 are isolated from each other. Thus, in lower slices the cross-section of the pillars are preferably isolated from each other so that their cross-sections form concave shapes, while in higher slices two or more of the pillars combine to form together a region that is not simply-connected.

In some embodiments of the present invention, the slice that corresponds to the uppermost layer of the stack, and preferably one or more slices that corresponds to layers immediately below the uppermost layer of the stack, includes a plurality of isolated islands at locations designated for the non-solid substance, wherein all other regions of the object's cross-section are designated to be occupied by building material(s) and thus form together a region that is not simply connected. Preferably, the size of the islands gradually decreases as one moves closer to the to the uppermost layer of the stack. The shape of the islands can be convex or concave, as desired. In the slice that corresponds to the uppermost layer of the stack the size of the islands is of a few pixels, more preferably a single pixel. A representative example of a slice 506 corresponding to the uppermost layer of the stack is illustrated in FIG. 5D, showing isolated islands of non-solid substance 614. Any slice that corresponds to layers that are above the topmost layer of the stack or below the bottommost layer of the stack, does not include data pertaining to the internal pillars or to the non-solid substance trapped between the pillars.

Referring again to FIG. 4, in some embodiments of the present invention the data received at 401 define a solid shape of three-dimensional object, and do not include information pertaining to the pillars, and their cross-sections. In these embodiments the method proceeds to 403 at which the digital data are processed to define the pillars. Preferably, the processing is executed on sliced data. Thus, when the digital data are non-sliced computer object data, the method preferably first applies slicing and then processes the slices to define the locations of the concave shapes 510. For example, the method can select the portion of the slices the defines the stack 610 of layer to encompass the pillars, and superimpose on each slice of this portion a two-dimensional array of concave shapes 510. Preferably, the two-dimensional array is periodic.

Preferably, the pillars are defined base on a ratio between the amount of modeling material and the amount of non-solid substance in stack 610. The ratio can be predetermined or be selected at 402, in which case operation 403 is executed after the selection 402 of the ratio. The ratio can be selected based on a property of the stack 610 which is optionally and preferably received by the method as input. The input property can be, for example, an overall weight of stack 610 or a proxy thereof (e.g., an overall weight of object 600, stack 602 and stack 604), a mass density of stack 610, one or more radiodensity values of stack 610, or the like.

Use of radiodensity value as an input property for stack 610 is particularly useful when it is descried to fabricate an object that resembles a bodily structure of a living body. Such objects are preferably non-biological and can have a variety of uses, including, without limitation, medical training, pre-surgical models, phantoms, implants and education examples.

The term “bodily structure” refers to a part of a body of a subject, as described herein, including systems, organs, tissues, cells and a surrounding environment of any of the foregoing. A bodily structure, for example, can comprise several organs acting together in a living body, for example, a gastrointestinal tract, a cardiovascular system, a respiratory tract, and the like. The structure can include, in addition to organs and tissues that form a part of these systems, also structures related to a pathology, for example, tumor cells or tissues. A bodily structure can alternatively include, for example, a heart and blood vessels associated therewith. A bodily structure can alternatively include an organ, such as, for example, an arm or forearm, or leg, and can encompass the related bones system and muscle tissues, blood vessels, tumor tissues (if present) and/or skin tissues in its surroundings.

The term “tissue” describes a part of an organism consisting of cells designed to perform a function or functions. Examples include, but are not limited to, brain tissue, retina, skin tissue, hepatic tissue, pancreatic tissue, bone, cartilage, connective tissue, blood tissue, muscle tissue, cardiac tissue, vascular tissue, renal tissue, pulmonary tissue, gonadal tissue, hematopoietic tissue.

Since stack 610 is composed of modeling material(s), which is/are solid, as well as of the non-solid substance, it is particularly suitable for mimicking organs and/or tissues which are relatively soft, typically softer than cortical bones.

When the input property comprises one or more radiodensity values, the radiodensity values can, in some embodiments of the present invention, be expressed in Hounsfield Units (HU). In some embodiments of the present invention the input radiodensity value is, or equivalent to, less than 100 HU, or less than 0 HU, or less than −100 HU or less than −200 HU or less than −400 HU or less than −800 HU, e.g.,−900 HU.

It is recognized that bodily structures can have properties that may vary among different living bodies. The input property may therefore be a property which is taken from the scientific literature as a characteristic average of the respective property across a group of individuals (e.g., humans of the same age, gender, ethnicity, etc.). The input property can, alternatively be specific to a particular living body. These embodiments are useful when the property includes one or more radiodensity values. For example, a portion of the digital data that corresponds to the layers that form stack 610 can describe a specific radiological image (e.g., a CT image) of a biological object, in which case the radiodensity value(s) based on which the ratio is selected can be the radiodensity value(s) that characterize the specific radiological image.

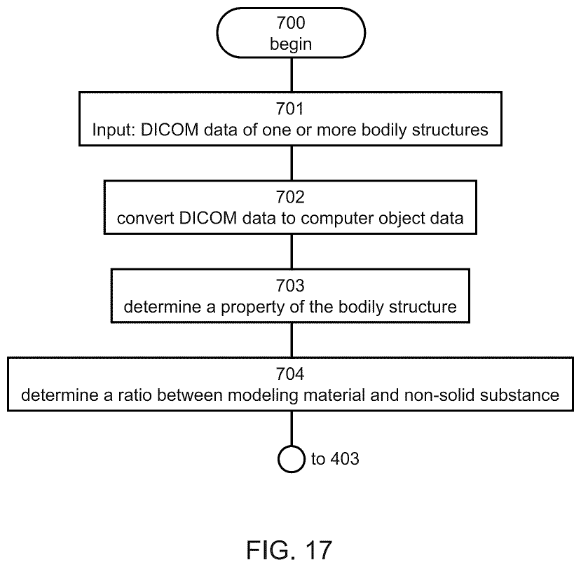

The present disclosure also contemplates embodiments in which the method determines the property of stack 610 automatically. For example, the method can receive image data of a radiological image and extract the radiodensity value(s) from grayscale levels of the radiological image, e.g., using a predetermined relationship between grayscale level and radiodensity, as known in the art. A more detailed description of an automated method that can be used for determining the ratio is provided below with reference to FIG. 17.

The method can select the ratio between the amount of modeling material and the amount of non-solid substance in stack 610 using a lookup table that provides a value of the ratio for each value or range of values of a particular property of the stack 610. Based on the selected ratio, the method can calculate the number and sizes of the pillars 612 to be formed in stack 610. For example, the method can form larger and fewer pillars when the input property is indicative of a higher weight or mass density or radiodensity, than when the input property is indicative of a lower weight or mass density or radiodensity.

In some embodiments of the present invention each slice of the portion that corresponds to the stack is eroded before the array is superimposed on the slice. The advantage of this operation is that it ensures that the array is superimposed only at the internal region 524 of the slice, without altering the slice data at the envelope region 522. The array to be superimposed on the slice is optionally and preferably obtained from a computer readable medium. The medium can store the entire array. However, in embodiments in which the array is periodic, it is sufficient to store in the medium a data structure that describes one or a few elementary cells of the periodic array. In these embodiments, the elementary cell(s) of the array that are read from the medium are used to tile the slice by periodically duplicating the elementary cell(s) over the area of the internal region 524.

The digital data (or the processed digital data if operation 403 is employed) can be transferred to a controller of an AM system (e.g., controller 20 of AM system 110 or 10) for sequentially dispensing and solidifying a plurality of layers based on the digital data. Specifically, referring conjointly to FIGS. 4 and 6, at 404 the AM system sequentially dispenses and solidifies the layers to form the stack 602 at the lower part of object 600, at 405 the AM system sequentially dispenses and solidifies the layers to form the stack 610 that encompasses the non-solid substance 614 and the pillars 612, and preferably also the peripheral wall 608 surrounding region 606, and at 406 the AM system sequentially dispenses and solidifies the layers to form the stack 604 at the upper part of object 600. The method ends at 407.

FIG. 17 is a flowchart diagram of a method 700 suitable for selecting the ratio between amounts of modeling material and trapped non-solid substance, according to various exemplary embodiments of the present invention. The method can be used as part of the operations of method 400. Typically, but not necessarily, method 700 is executed instead of operations 410 and 402.

The method begins at 700 and optionally and preferably continues to 701 at which data in a format suitable for Digital Imaging and Communications in Medicine (hereinafter DICOM data) are received. The DICOM data can be received from an acquisition console such as, but not limited to, a CT imaging system, a helical CT system, a positron emission tomography (PET) system, a 2D or 3D fluoroscopic imaging system, a 2D, 3D, or 4D ultrasound imaging system, an endoscope system, a bedside monitor system, an x-ray system, an MRI system, and a hybrid-imaging system capable of CT, MR, PET, ultrasound or other imaging techniques. The DICOM data preferably includes one or more digital image data describing one or more bodily structures comprising one or more bodily tissue and/or organ elements. In some embodiments of the present invention DICOM data preferably includes one or more digital image data describing one or more soft tissues or organs or systems comprising soft tissues, in some embodiments of the present invention DICOM data preferably includes one or more digital image data describing one or more bodily structures comprising one or more bodily organ and/or tissue elements other than a soft tissue, and in some embodiments of the present invention DICOM data preferably includes one or more digital image data describing one or more bodily soft tissues, and also one or more digital image data describing one or more bodily structures comprising one or more bodily organ and/or tissue elements other than a soft tissues.

The method optionally and preferably continues to 702 at which the DICOM data are converted to computer object data. For instance, the computer object data can be in any one of the aforementioned formats. The conversion from DICOM data to computer object data optionally and preferably includes one or more segmentation procedures, selected from the group consisting of thresholding, region growing, dynamic region growing, and the like.

Thresholding procedures exploit the differences in density of different tissues to select image pixels with a higher or equal value to a prescribed threshold value. For example, a prescribed threshold value of a thresholding procedure can be selected so that image pixels with regard to hard tissue pass the thresholding procedure, and other image pixels relating are filtered out. The thresholding procedure can be applied multiple times each time using a different threshold value, so as to obtain separate datasets for different tissue types.

Region growing procedures are typically applied after thresholding to isolate areas which have the same density range. A region growing procedure can examine neighboring pixels of initial seed points and determines whether the neighboring pixels belong to the region. The procedure is optionally and preferably performed iteratively to segment the image. For example seed points can be selected according to different tissue types and the region growing segmentation techniques can be performed iteratively to separate image pixels as belonging to one of these tissue types. In dynamic region growing, a range of image parameters are selected in addition to the seed points. These parameters are selected to allow recognizing an image pixel as the same as the seed points.

Typically, but not necessarily, an initial background segmentation procedure is applied for removing from the DICOM data elements that do not belong to any of the tissue types of interest. Subsequent segmentation procedures can then be applied for more refined segmentation of one or more refined area of a subject's anatomy by using different segmentation techniques.

Following segmentation, the conversion from DICOM data to computer object data can also include smoothing, wrapping and/or hole-filling to compensate for artifacts within the DICOM data. A format conversion procedure can then be applied to the segmented DICOM data so as to provide the computer object data in in any of the aforementioned formats.

The computer object data preferably include data pertaining to a shape of one or more bodily structures comprising one or more bodily tissue element as further detailed hereinabove. The computer object data can, in some embodiments of the present invention, be optionally and preferably arranged in multiple files, each pertaining to a different bodily structure.

At 703 a property of the bodily structure to be mimicked by an additive manufactured object is determined for each data file (when more than one such file exists). The property can be any of the aforementioned properties (weight, mass density, radiodensity), and can be determined by extracting information present in the respective DICOM data file. Such information can be in the form of intensity levels or greyscale values stored in the various picture-elements of the DICOM data file, or in the form of metadata associated with the respective DICOM data file.

At 704, a ratio between the amount of modeling material and the amount of non-solid substance in stack 610 is determined, based on the property as determined at 703. The ratio can be selected using a lookup table that is prepared in advance and that provides a value of the ratio for each value or range of values of a particular determined property.

From 704 the method optionally and preferably proceeds to operation 403 of method 400.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

This Example describes representative procedures for forming the trapping pillars according to some embodiments of the present invention.

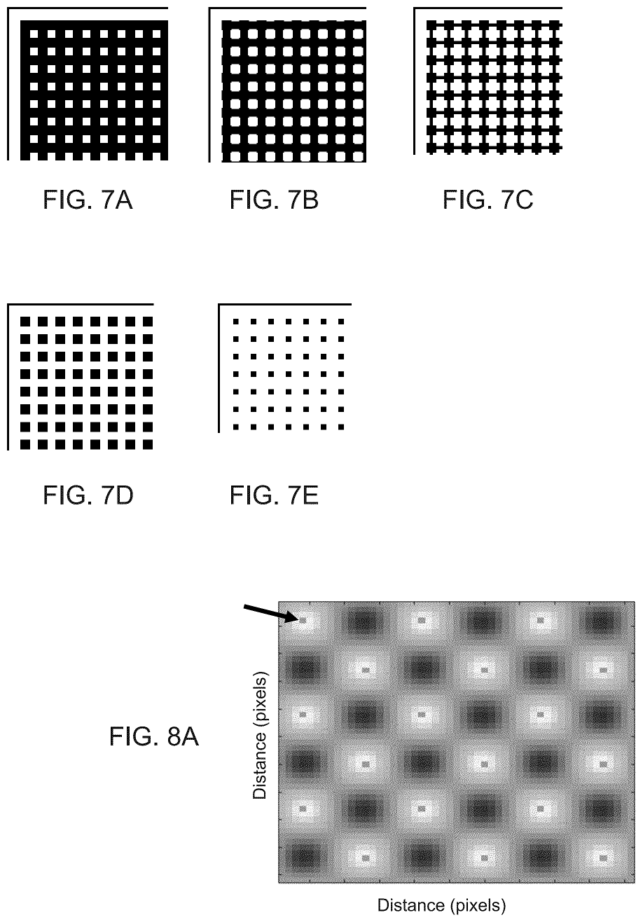

FIG. 7A illustrates a portion of a slice describing a layer of an object having a square cross-section. In the slice of FIG. 7A, white color designates building material and black designates regions comprising a non-solid substance (air, in the present example). Shown is an outer solid square wall and multiple square pillars isolated from each other and arranged in a rectangular grid. FIG. 7B illustrates a slice above the slice of FIG. 7A, in which the cross-sections of the pillar are larger, so that arches are beginning to form. FIG. 7C illustrates a slice above the slice in FIG. 7B, in which the cross-sections of the pillars are even larger so that the arches begin to close. FIG. 7D illustrates a slice above the slice in FIG. 7C, in which the arches have closed to form a rectangular grid of building material walls surrounding isolated islands of air. FIG. 7E illustrates a slice above the slice in FIG. 7D, in which the walls between the islands become thicker and the islands diminish in size. In higher layers this proceeds until the islands become of one pixel in size, and then disappear, so that the top of the object is as solid as its walls.

This example relates to an object in which the height is essentially constant across (x,y). The present disclosure also contemplates embodiments in which a slice comprises regions looking like any of FIGS. 7A-E as well as interpolations and/or combination between them.

Following is an example for defining the cross-sections of the pillars using a two-variable periodic function. In this Example, a sinusoidal two-variable periodic function is employed, but other functions can be used, provided they have a periodicity and a plurality of maxima.

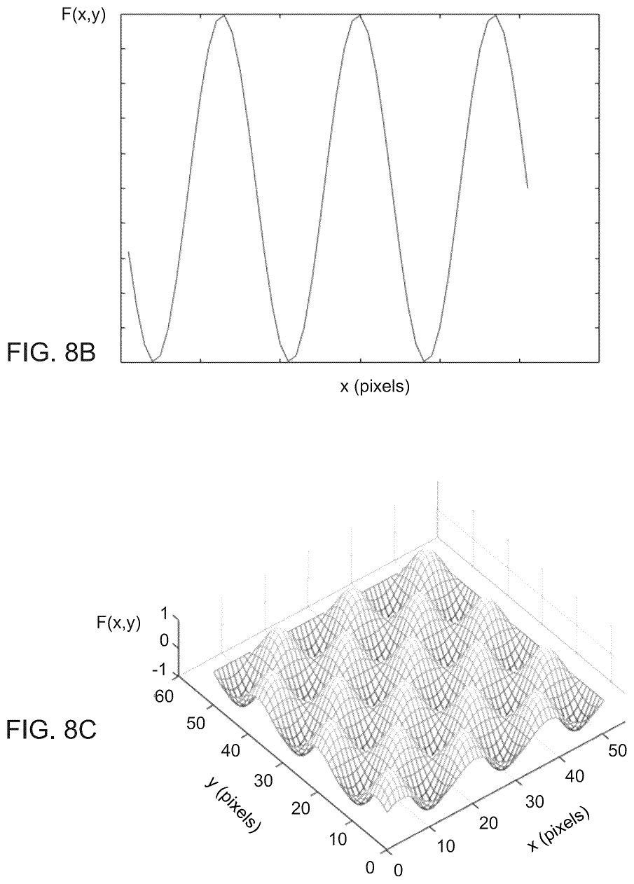

FIG. 8A is contour plot of the function Z=F(X,Y)=sin(αX)sin(βY) showing the maxima and the equivalued lines of the function. In this example, the function has a period of 17 pixels in both the X and Y directions and the plot in FIG. 8A shows three repetitions of the period. As shown, the plot has 3×3×2 maxima. One of the maxima is marked by an arrow. A two-dimensional plot of the function F (X, Y) for fixed Y is shown in FIG. 8B, and a three-dimensional plot of the function F(X,Y) is shown in FIG. 8C. The data describing the function F(X, Y) can be represented digitally by a two-dimensional array of values, referred to herein as EggsContainer. For the purpose of locating the maxima, there is no need to consider whether or not the printed object is of constant height.

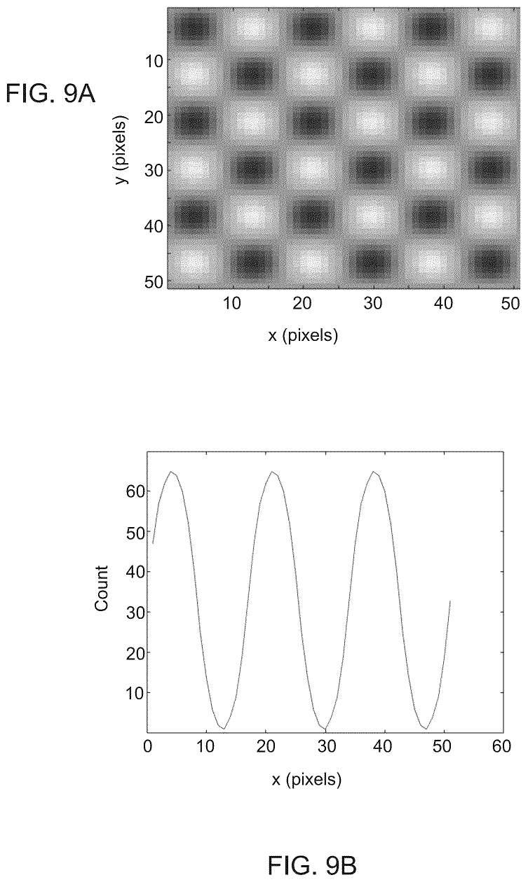

According to some embodiments of the present invention a two-dimensional array named Count is generated. The Count array is of the same size as the EggsContainer array. Elements in the Count array that correspond to the maxima of the EggsContainer array are assigned the integer value of 1, elements where the EggsContainer is not more the 1% lower that the local maxima are assigned the value 2, locations 1% lower are assigned 3, and so on. Other percentage steps are also contemplated. In the present example the Count array includes 65 integer steps. A contour plot of the Count array is shown in FIG. 9A, and a two-dimensional plot of the Count array, as a function of X for fixed Y is shown in FIG. 9B.

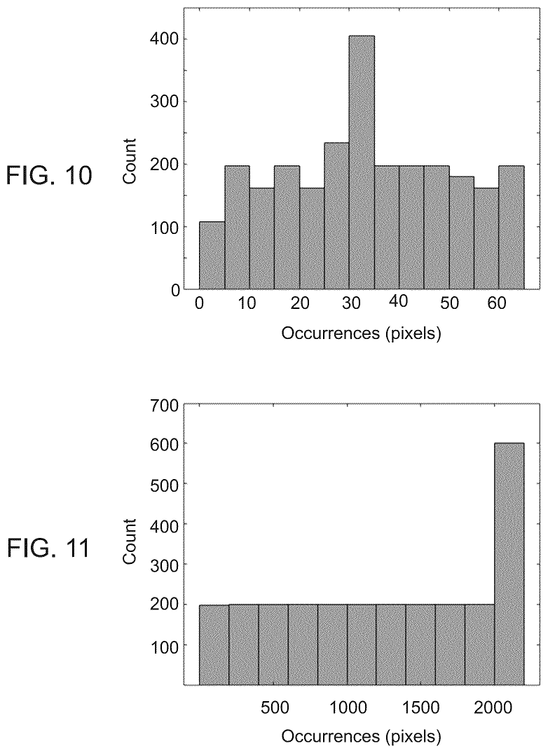

Initially, the number of pixels in Count having each of the 65 values is not evenly distributed, as shown by the histogram in FIG. 10. In some embodiments of the present invention a histogram equalization procedure is applied to the Count array, as follows.

A two-dimensional array, BCount, having a flat histogram is created. The array is of the same size as Count (51×51, in the present Example). In this array there is one pixel of value 1, one of value 2 etc. The number of values is trimmed to a smaller number, according to a predetermined threshold percentage (for example 80%) of the number of elements of BCount (2601 in the present Example). Since there are 3×3×2 maxima, the BCount has 116 steps per maximum. The following procedure is employed. Start with a new matrix of zeros the size of the Count matrix. Then start with a counter b set to zero. Loop though values from 1 to the maximum number in the Count array in steps of 1. Find all elements in the Count array that have that value. For each of these elements, in some random order, increase the counter b by one, and place the value of the counter b at the same element but of the BCount array. Values at the new matrix are selected to be less than a predetermined number.

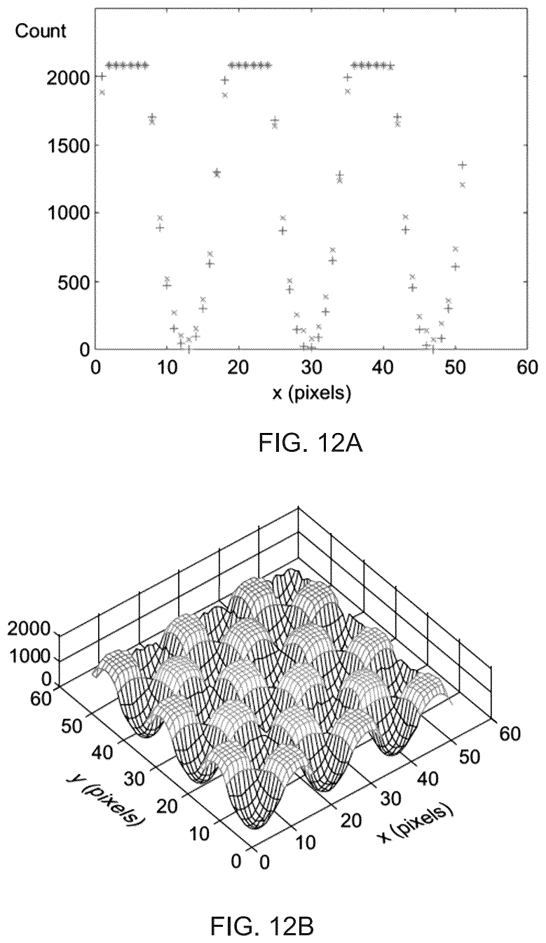

FIG. 11 shows an equalized histogram formed by the above procedure, and FIGS. 12A and 12B show, respectively, a two-dimensional plot of equalized BCount array for fixed Y, and a three-dimensional plot of equalized BCount array. Note that the width of the flat regions in FIG. 12A determines the width of the pillars at the lower slices. Therefore, the aforementioned threshold percentage (e.g., 80%) is preferably selected in regarding the desired pillar diameter, and preferably regarding the recommendation for the diameters disclosed herein.

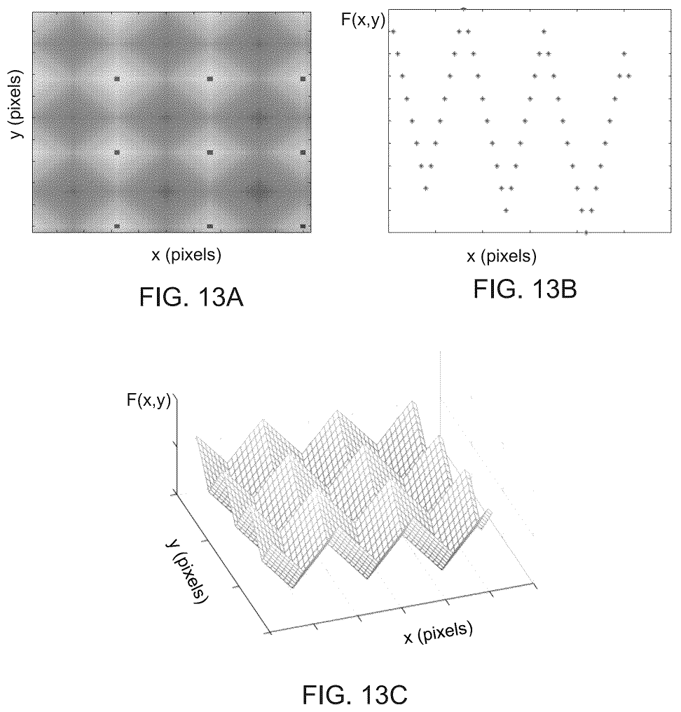

While the examples above were described for a periodic function which is sinusoidal, other two-variable periodic functions are also contemplated. For example, FIGS. 13A, 13B, and 13C show, respectively, a contour plot, a two-dimensional plot at fixed Y, and a three-dimensional plot of a triangular wave function.

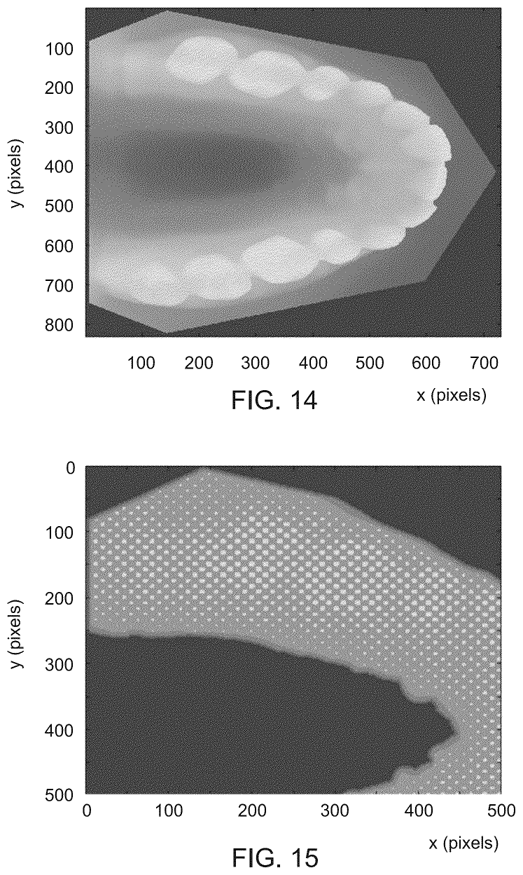

Once the arrays are defined, they can be used for all fabricated objects. Following is a description of an exemplified procedure suitable for using the arrays for the fabrication of an object. A height map of the model is calculated. The height map provides the maximal height of the object to be fabricated at each pixel of its footprint. A representative example of a height map of an exemplified object is shown in FIG. 14. The slices of the data are then eroded to define the internal region at which the pillars are to be formed. The BCount array is then used to loop through the layers to create the air voids. Preferably, the following computer procedure is employed.
1) Replicate the BCount array along both dimensions X and Y until it covers the footprint of the slice. Alternatively, consider the XY coordinates of a voxel in the slice as modulo the size of BCount.
2) Stretch the Bcount function so that the range of values fit the height of the object, as determined using the height map.
3) For each layer:
   (i) Calculate, for each pixel in the layer, the number of layers above it. This parameter is referred to as DepthCount. A pixel outside the object may be assigned with a DepthCount of 0, and the same can be applied to pixels that are not sufficiently inside the model, to within some predefined thickness.
   (ii) Update the values assigned for voxels in the layer according to a comparison between DepthCount and DCount, the latter being an array of the dimensions of the footprint of the object, which is initialized to 0, and which is used to count the depth of a trapped aid at each pixel location, if exists.

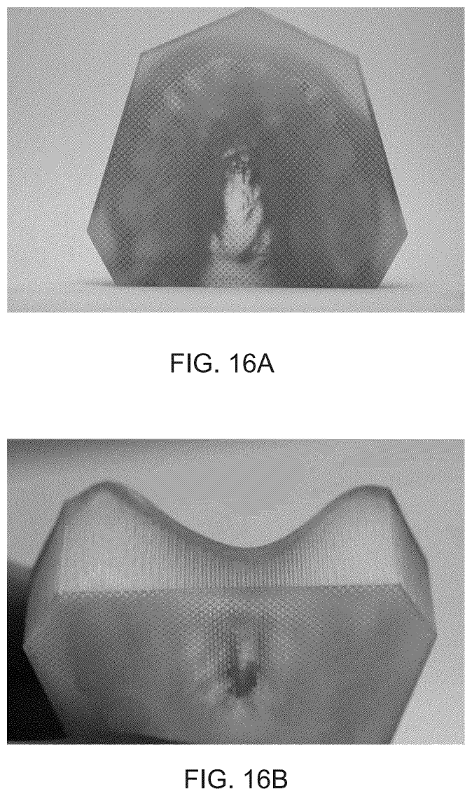

A representative example of an exemplified slice describing a layer of the object is illustrated in FIG. 15. Images of a three-dimensional object fabricated according to some exemplary embodiments of the invention using slices similar to the slice shown in FIG. 15 are shown in FIGS. 16A and 16B.

### Example 2

This Example demonstrates the ability of the pillars of the present embodiments to provide a stack characterized by negative HU values.

Three-dimensional dental arches were fabricated using a three-dimensional printing system (J55 3D Printer, Stratasys®, Israel). The modeling material used was VeroClear™, by Stratasys, Israel, and the non-solid substance was air. The size of the pillars was varied horizontally across the fabricated dental arches so as to achieve various different ratios between the amounts of modeling material and air.

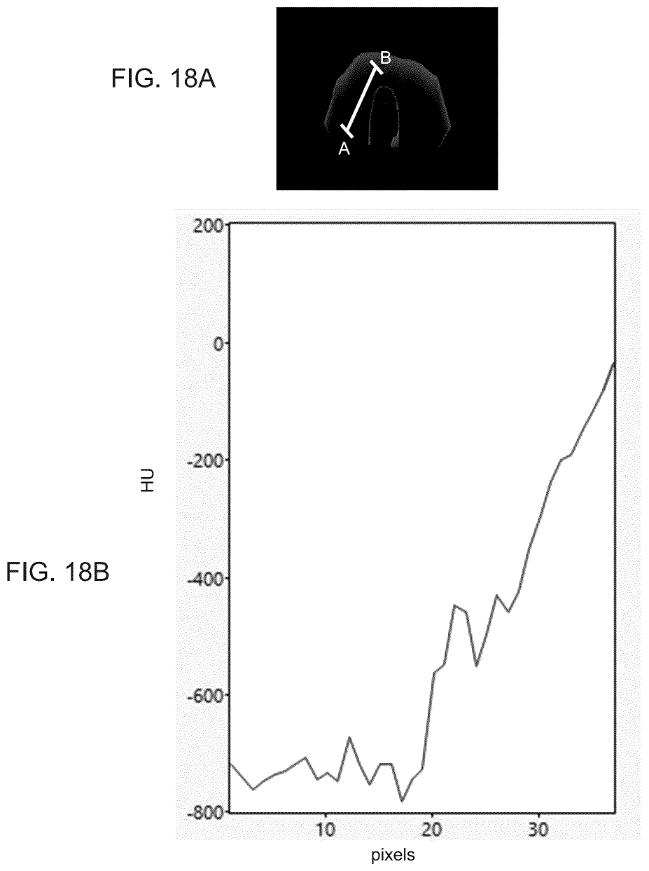

All dental arches were scanned in a clinical Philips CT iCT 256 scanner, and the radiodensity values in HU scale were extracted from the greyscale levels in the pixels of the scans. FIG. 18A is a CT scan of one of the fabricated dental arches. FIG. 18B shows the extracted radiodensity values along the line A-B shown in FIG. 18A. In FIG. 18B the abscissa indicates the distance in pixels from point A along the line A-B, and the ordinate indicates the respective radiodensity value in HU. As shown, the method of the present embodiments usefully provide objects having negative HU values. Experiments performed using a different printer (J850 3D Printer, Stratasys®, Israel), provided similar results (data not shown).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention.

To the extent that section headings are used, they should not be construed as necessarily limiting. In addition, any priority document(s) of this application is/are hereby incorporated herein by reference in its/their entirety.

1. A method of additive manufacturing, comprising:
receiving digital data defining a shape of a three-dimensional object; and
based on said digital data, sequentially dispensing and solidifying a plurality of layers arranged in a configured pattern corresponding to said shape of said object and being made of a modeling material,
wherein a portion of said layers forms a stack encompassing a non-solid substance trapped between a plurality of building material pillars oriented perpendicularly to said layers, and wherein for each layer of said stack, a cross-section of each pillar at said layer forms a closed concave shape having a size that gradually increases with a vertical position of said layer along said stack.

2. The method according to claim 1, wherein said concave shape has rounded corners.

3. The method according to claim 2, wherein said concave shape is devoid of non-rounded corners.

4. The method according to claim 1, wherein said concave shape has at least four lobes pointing outwardly with respect to a center of said concave shape.

5. The method according to claim 1, wherein at least a portion of said pillars are interconnected thereamongst.

6. The method according to claim 4, wherein at least a portion of said pillars are interconnected thereamongst.

7. The method according to claim 6, wherein said at least said portion of said pillars are interconnected at said lobes.

8. The method according to claim 5, wherein said stack comprises a lower part and an upper part, and wherein said pillars are interconnected via interconnects that are at said upper part.

9. The method according to claim 8, wherein said lower part of said stack is devoid of interconnects among said pillars.

10. The method according to claim 1, wherein for each layer of said stack, a collection of concave shapes is distributed over said layer to form a two-dimensional periodic array.

11. The method according to claim 10, wherein three-dimensional locations of said non-solid substance are described collectively by a two-variable periodic function having a plurality of discrete maxima.

12-13. (canceled)

14. The method according to claim 1, wherein said received digital data define a shape of said three-dimensional object including said pillars.

15. The method according to claim 1, wherein said received digital data define a solid shape of said three-dimensional object, and the method comprises processing said digital data to define said pillars, wherein said dispensing is based on said processed data.

16. The method according to claim 15, wherein said digital data is arranged over a plurality of slices, each describing a cross-section of said solid shape and corresponding to one of said plurality of layers, and wherein the method comprises selecting a portion of said slices and superimposing on each slice of said portion a two-dimensional periodic array of concave shapes, each describing a cross-section of one of said pillars at a layer corresponding to said slice.

17. The method according to claim 16, comprising eroding each slice of said portion prior to said superimposing.

18-20. (canceled)

21. The method according to claim 1, comprising receiving at least one radiodensity value as input and selecting a ratio between amounts of said modeling material and said trapped non-solid substance based on said at least one radiodensity value.

22. (canceled)

23. The method according to claim 1, wherein a portion of said digital data corresponding to said portion of said layers describes a radiological image of a biological object, and the method comprises selecting a ratio between amounts of said modeling material and said trapped non-solid substance based on at least one radiodensity value characterizing radiological image.

24. (canceled)

25. The method according to claim 23, comprising obtaining said at least one radiodensity value from grayscale levels of said radiological image.

26. (canceled)

27. A system of three-dimensional printing, comprising:
a plurality of nozzle arrays configured for dispensing building materials;
a solidification system configured for solidifying said materials; and
a data processor having a circuit configured to receive digital data arranged over a plurality of slices each describing a cross-section of a layer of a three-dimensional object, to select a portion of said slices, and to superimpose on each slice of said portion a two-dimensional array of concave shapes; and
a computerized controller having a circuit configured for operating said nozzle arrays and said solidification system to sequentially dispense and solidify a plurality of layers, respectively corresponding to said plurality of slices;
wherein a portion of said layers corresponding to said portion of said slices forms a stack encompassing a non-solid substance trapped between a plurality of building material pillars oriented perpendicularly to said layers, and wherein for each layer of said stack, a cross-section of each pillar at said layer forms a closed concave shape having a size that gradually increases with a vertical position of said layer along said stack.

28. A computer software product, comprising a computer-readable medium in which program instructions are stored, which instructions, when read by a data processor, cause the data processor to receive digital data arranged over a plurality of slices each describing a cross-section of a layer of three-dimensional object, to select a portion of said slices, and to superimpose on each slice of said portion a two-dimensional array of concave shapes;
wherein said portion of said slices defines a stack of layers encompassing a non-solid substance trapped between a plurality of building material pillars oriented perpendicularly to said layers, wherein for each layer of said stack, a cross-section of each pillar at said layer forms one closed concave shape of a two-dimensional array of a slice corresponding to said layer, and wherein a size of said closed concave shape gradually increases with a vertical position of said layer along said stack.
